(19) United States
(12) Patent Application Publication
(10) Pub. No.: US 2016/0281958 A1
(43) Pub. Date: Sep. 29, 2016

(54) Retrofit Light Emitting Diode Fixture for a Black Box

(71) Applicant: Gary Wayne Engelhardt, San Jose, CA (US)

(72) Inventor: Gary Wayne Engelhardt, San Jose, CA (US)

(21) Appl. No.: 15/083,279

(22) Filed: Mar. 28, 2016

Related U.S. Application Data
(60) Provisional application No. 62/139,500, filed on Mar. 27, 2015.

(51) Int. Cl. F21V 7/04; F21V 3/04; F21K 99/00

(52) U.S. Cl. CPC F21V 7/04; F21K 9/17; F21V 3/0436; F21Y 2101/02; F21Y 2103/003

(57) ABSTRACT

A retrofit light emitting diode fixture for a back-box is used to replace fluorescent bulbs.

The current application claims a priority to the U.S. Provisional Patent application Ser. No. 62/139,500 filed on Mar. 27, 2015. The current application is filed on Mar. 28, 2016 while Mar. 27, 2016 was on a weekend.

### FIELD OF THE INVENTION

The present invention relates generally to light emitting diode fixtures. More specifically, the present invention is retrofit light emitting diode fixture for a black box.

### BACKGROUND OF THE INVENTION

Thermal management has been the focus of light delivery systems as performance lighting increased in popularity. However, the distribution and glare of the light are problems of current light delivery systems with fluorescent light bulbs. Typical lenses engaged with these light delivery systems comprise a material that prevents light from passing through with only eighty-six percent lens transmission, resulting in uneven distribution. A solution to this issue is the use of LED bulbs. The use of LED bulbs has proven to be insufficient in reflecting the light that has bounced back from the lens back through the lens.

The present invention is a light delivery system that offers the best distribution and eliminates the glare of traditional light delivery systems. As the lens material prevents the light emitted from a light source, preferably an LED bulb, from passing through the lens, the white optics material installed on the face of both reflectors successfully directs the light through the lens. The light emitted of the present invention is distributed at a perfect forty degrees. The present invention may be used as a retrofit lamp replacement, a linear universal light engine, signage lights, accent lights, roadway lights, and so on.

### BRIEF DESCRIPTION OF THE DRAWINGS

FIG. 1 through 8 illustrate the present invention.

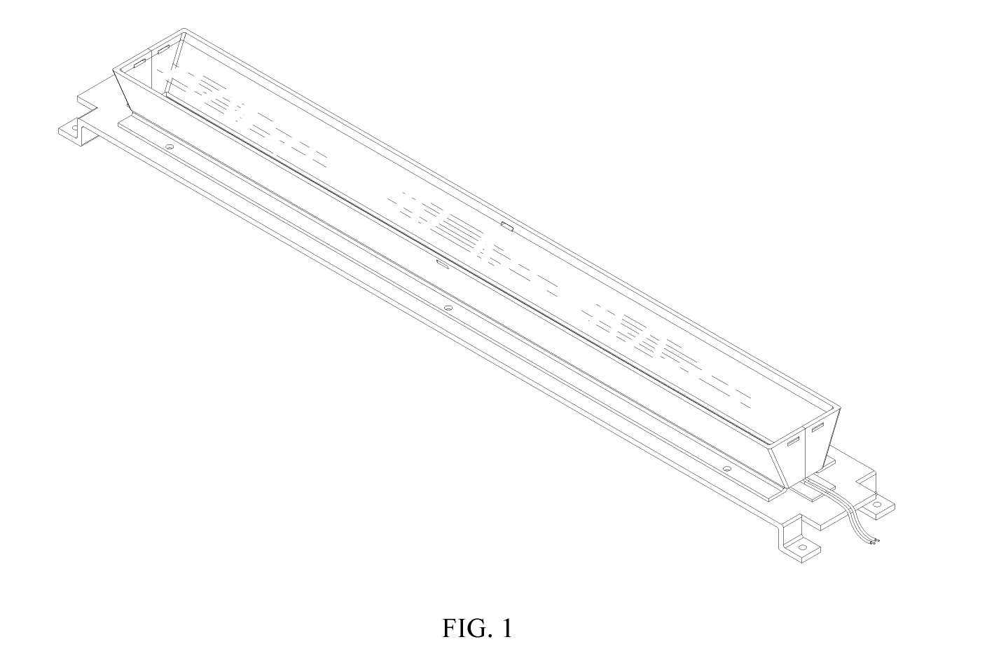

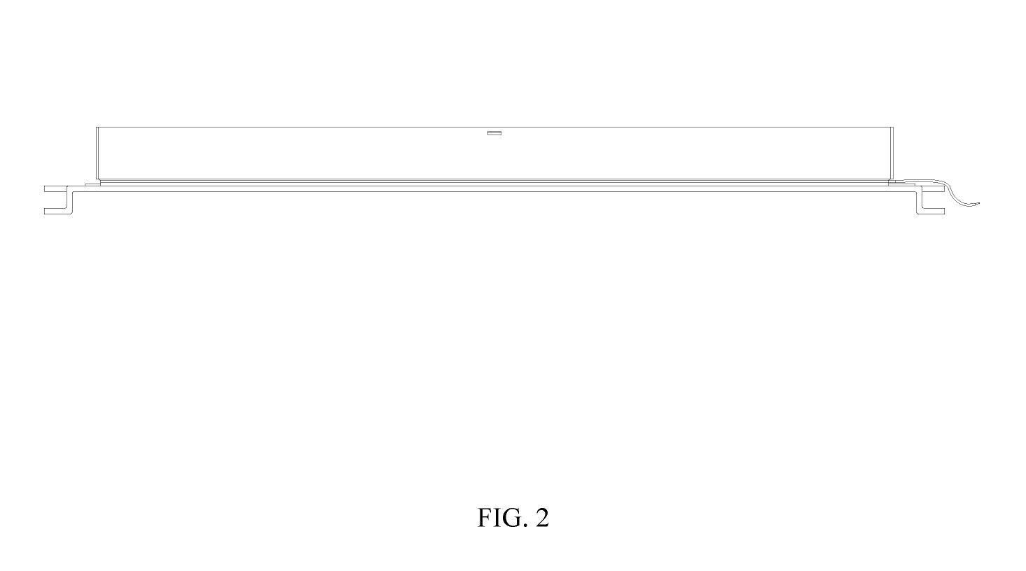

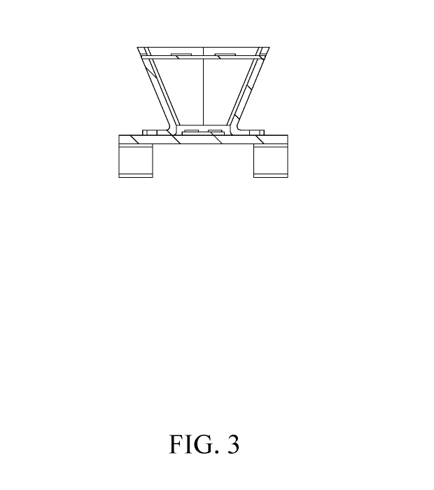

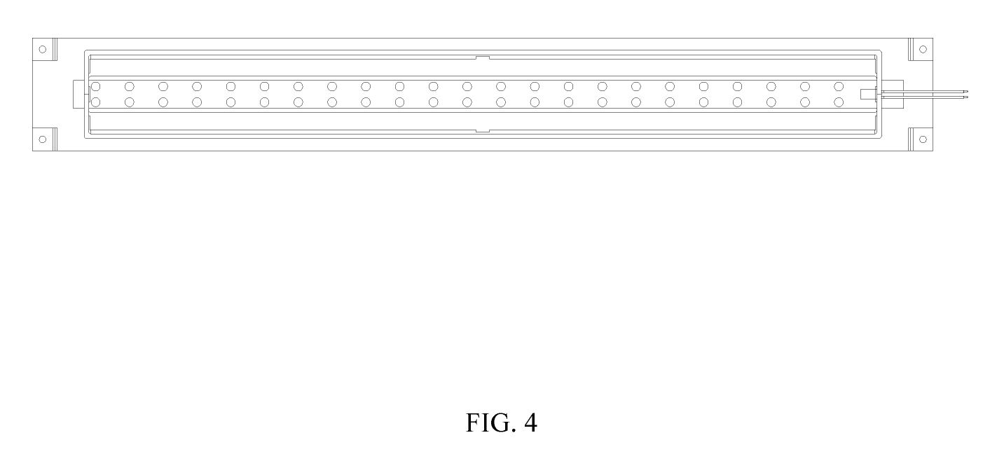

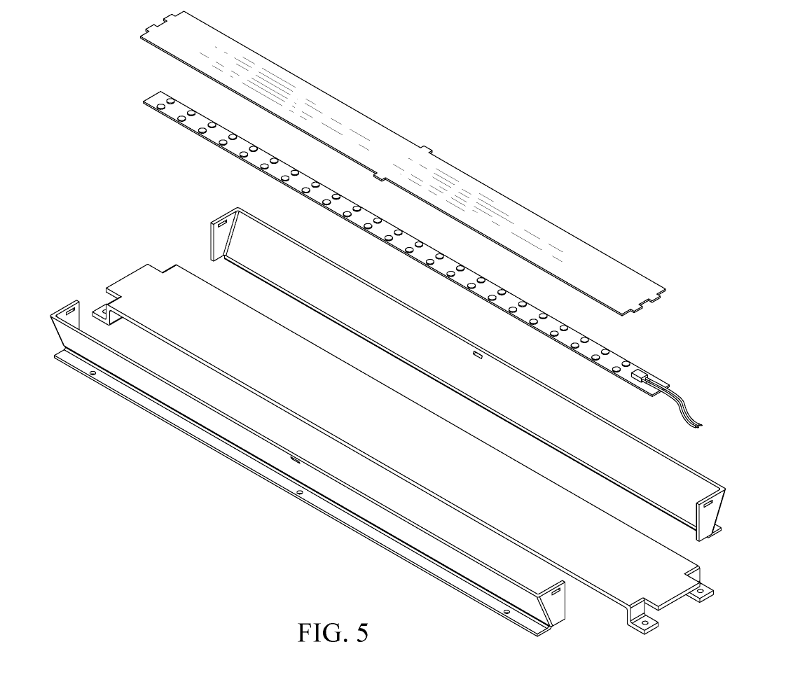

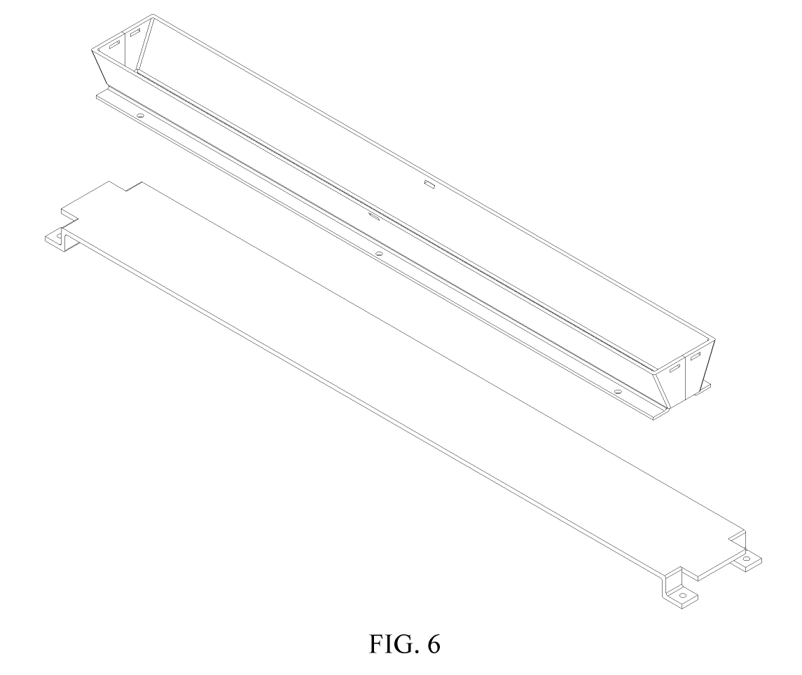

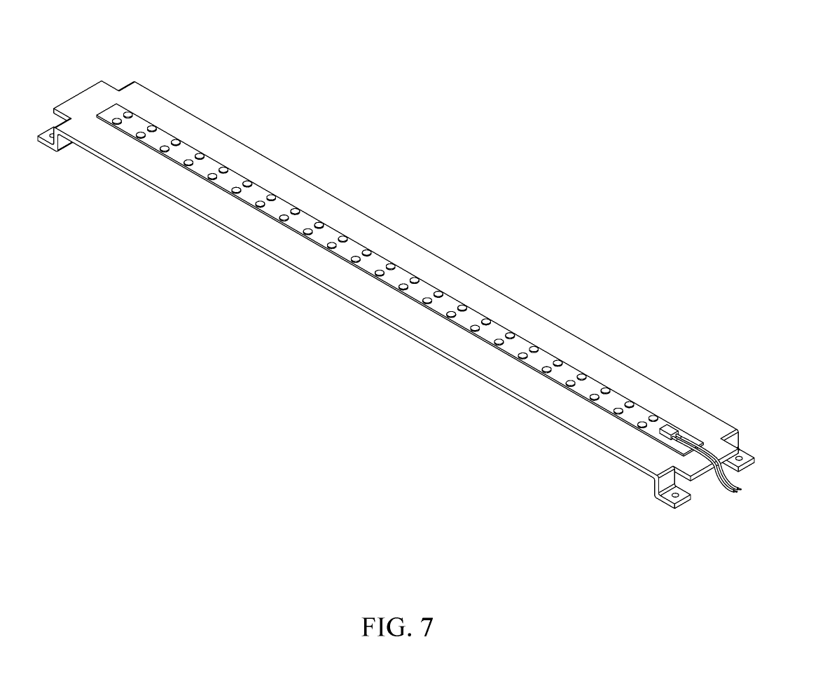

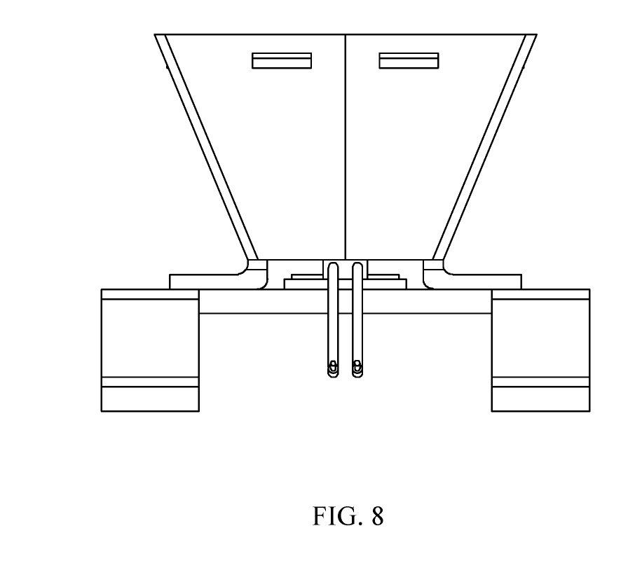

### DETAILED DESCRIPTION OF THE INVENTION

All illustrations of the drawings are for the purpose of describing selected versions of the present invention and are not intended to limit the scope of the present invention.

The present invention is a retrofit light emitting diode fixture for a back-box that is used in replacement of exiting fluorescent tubes and incandescent lamps. The present invention is designed to be mounted into a variety of light fixture housings. The present invention is also designed to evenly distribute light so that the surrounding area receives the maximum amount of illumination. The present invention comprises a base plate, a light directing fixture, a low transparency lens, a light source assembly, a first white optics reflector, and a second white optics reflector. The base plate provides a structural foundation to connect the other components of the present invention into a back-box or some similar light fixture housing. Light that is emitted by the light source assembly is bounced between the low transparency lens and the first white optics reflector and the second white optics reflector, all of which is held in place by the light directing fixture. The light bounces back and forth within the light directing fixture until the intensity of the light increases to a point where the light passes through the low transparency lens and generates pure illumination without glare. In the preferred embodiment of the present invention, the low transmission lens is made of a frost acrylic material that has an 86% optical transmission. Also in the preferred embodiment, the first white optics reflector and the second white optics reflector are 98% reflective.

The general configuration of the aforementioned components allows the present invention to efficiently and effectively illuminate its surrounding areas. The light source assembly and the light directing fixture are mounted onto the base plate in order to maintain a constant emission direction for the light generated by the light source assembly. The light source assembly is positioned into an input opening for the light directing fixture, while the low transparency lens is mounted into an output opening for the light directing fixture, which allows the light source assembly and the low transparency lens to be in optical communication with each other through the light directing fixture. The first white optics reflector and the second white optics reflector need to be mounted within the light directing fixture, which creates a space within the light directing fixture for light to bounce back and forth and build up its intensity before escaping through the low transparency lens.

In order to describe the optical path of light through the present invention, a sagittal plane needs to be defined for the present invention. The sagittal plane traverses through the base plate, the light directing fixture, the light source assembly, and the low transparency lens so the sagittal plane creates a bilateral symmetry through the present invention. The first white optics reflector is oriented at a first acute angle with the sagittal plane, and the second white optics reflector is oriented at a second acute angle with the sagittal plane. Moreover, the first acute angle and the second acute angle are equal in magnitude to each other but are oriented in opposite directions from the sagittal plane. This creates a V-shaped formation between the first white optics reflector and the second white optics reflector. In the preferred embodiment of the present invention, the first acute angle and the second acute angle are both 20 degrees in magnitude. In addition, the light directing lens and the base plate are positioned parallel to each other so that the present invention emits light in a normal direction from where the base plate is mounted. The arrangement between the first white optics reflector, the second white optics reflector, and the low transmission lens allows the light emitted from the light source assembly to bounce several time between the first white optics reflector, the second white optics reflector, and the low transmission lens in what is known as a fracturing event, which is used to generate the pure illumination with no glare.

The mounting plate attaches the present invention to a variety of light fixture housings. The base plate is preferably connected to a mounting surface by a plurality of fasteners. Each of the plurality of feet comprises a first tab and a second tab. The first tab and second tab lifts up the base plate from the mounting surface by a certain offset distance. The first tab is positioned adjacent the mounting plate. The first tab is used to define the offset distance between the base plate and the mounting surface. The second tab connects the base plate to the mounting surface of a light fixture via one of the plurality of fasteners. The first tab is mounted in between the mounting plate and the second tab. In the preferred embodiment of the present invention, the first tab is positioned perpendicular to the mounting plate, and the second tab is positioned parallel to the mounting plate. This forms an L-shaped foot between the first tab and the second tab that is able to most effectively receive the load from the mounting plate.

In order to properly secure the low transparency lens in place, the light directing fixture needs to further comprise a plurality of tab-receiving slots, while the low transparency lens needs to further comprise a lens body and a plurality of tabs. The lens body is responsible for the optical capabilities of the low transparency lens. The plurality of tabs is used to secure the positioning of the lens body and are peripherally connected about the lens body. The plurality of tab-receiving are position adjacent to the output opening of the light directing fixture so that each of the plurality of tabs can be engaged to a corresponding slot from the plurality of tab-receiving slots.

In some embodiments of the present invention, the light directing fixture is designed to be easily assembled by a user and, consequently, further comprises a left bracket and the right bracket, which are mirroring pieces of the light directing fixture. The left bracket and the right bracket can be found on opposing sides of the sagittal plane. Moreover, the left bracket and the right bracket each comprise a main panel, a first lateral wall, and a second lateral wall. The first lateral wall is positioned adjacent to the main panel, and the second lateral wall is positioned adjacent to the main panel, opposite the first lateral wall. This configuration for the first lateral wall, the second lateral wall, and the main panel forms the overall shape of either the left bracket or the right bracket. Moreover, the first lateral wall of the left bracket is positioned adjacent to the first lateral wall of the right bracket, opposite to the main panel of the right bracket, and the second lateral wall of the left bracket is adjacent to the second lateral wall of the right bracket, opposite the main panel of the right bracket. This configuration between the left bracket and the right bracket forms an enclosure with two open ends (the input opening and the output opening) so that the enclosure is able to guide light from the light source assembly to the low transparency lens. Consequently, the main panel of the left bracket and the main panel of the right bracket are able to secure the positioning of the first white optics reflector and the positioning of the second white optics reflector. This is because the first white optics reflector is mounted across the main panel of the left bracket, and the second white optics reflector is mounted across the main panel of the right bracket. Also in the preferred embodiment of the present invention, the left bracket and the right bracket are made of aluminum, which allows the present invention to safely function with a heat sink.

The light source assembly is able to used low power electrical components in order to generate the necessary illumination for the present invention. Thus, the light source assembly comprises a base strip, a plurality of light emitting diode (LED) bulbs, a constant current driver, and a power terminal. The base strip is mounted onto the base plate and is used to secure the light source assembly to the rest of the present invention. The plurality of LED bulbs is used to generate the light that is necessary to illuminate the surrounding areas of the present invention. The plurality of LED bulbs is mounted onto the base strip, opposite the base plate, and is distributed along the base strip so that the plurality of LED bulbs is able to evenly illuminate the surrounding areas. In addition, each of the plurality of LED bulbs is electrically connected to the power terminal through the constant current driver. The power terminal provides the plurality of LED bulbs with the necessary electrical power, and the constant current driver prevents fluctuations in the electrical power being delivered to the plurality of LED bulbs.

Although the invention has been explained in relation to its preferred embodiment, it is to be understood that many other possible modifications and variations can be made without departing from the spirit and scope of the invention as hereinafter claimed.

What is claimed is:

1. A retrofit light emitting diode (LED) fixture for a back-box comprises:
a base plate;
a light directing fixture;
a low transparency lens;
a light source assembly;
a first white optics reflector;
a second white optics reflector;
the light directing fixture comprises an input opening and an output opening;
the light source assembly and the light directing fixture being mounted onto the base plate;
the light source assembly being positioned into the input opening;
the first white optics reflector and the second white optics reflector being mounted within the light directing fixture;
the low transparency lens being mounted into the output opening;
a sagittal plane symmetrically traversing through the base plate, the light directing fixture, the light source assembly, and the low transparency lens;
the first white optics reflector being oriented at a first acute angle with the sagittal plane;
the second white optics reflector being oriented at a second acute angle with the sagittal plane;
the first acute angle and the second acute angle being equal in magnitude to each other and being oriented in opposite directions from the sagittal plane; and
the light directing lens and the base plate being positioned parallel to each other.

2. The retrofit LED fixture for a back-box as claimed in claim 1 comprises:
a plurality of feet;
each of the plurality of feet comprises a first tab and a second tab;
the plurality of feet being peripherally positioned about the base plate;
the first tab being positioned adjacent to the base plate; and
the second tab being positioned adjacent to the first tab, opposite the base plate.

3. The retrofit LED fixture for a back-box as claimed in claim 2 comprises:
the first tab being positioned perpendicular to the base plate; and
the second tab being positioned parallel to the base plate.

4. The retrofit LED fixture for a back-box as claimed in claim 1 comprises:
the light directing fixture comprises a plurality of tab-receiving slots;
the low transparency lens comprises a lens body and a plurality of tabs;
the plurality of tab-receiving slots positioned adjacent to the output opening;
the plurality of tabs being peripherally connected about the lens body; and
each of the plurality of tabs being engaged to a corresponding slot from the plurality of tab-receiving slots.

5. The retrofit LED fixture for a back-box as claimed in claim 1 comprises:
the first acute angle being 20 degrees in magnitude; and
the second acute angle being 20 degrees in magnitude.

6. The retrofit LED fixture for a back-box as claimed in claim 1 comprises:
the light directing fixture comprises a left bracket and a right bracket;
the left bracket and the right bracket each comprises a main panel, a first lateral wall, and a second lateral wall;
the first lateral wall being positioned adjacent to the main panel;
the second lateral wall being positioned adjacent to the main panel, opposite to the first lateral wall;
the first lateral wall of the left bracket being positioned adjacent to the first lateral wall of the right bracket, opposite to the main panel of the right bracket; and
the second lateral wall of the left bracket being positioned adjacent to the second lateral wall of the right bracket, opposite to the main panel of the right bracket.

7. The retrofit LED fixture for a back-box as claimed in claim 6 comprises:
the first white optics reflector being mounted across the main panel of the left bracket; and
the second white optics reflector being mounted across the main panel of the right bracket.

8. The retrofit LED fixture for a back-box as claimed in claim 1 comprises:
the light source assembly comprises a base strip, a plurality of LED bulbs, a constant current driver, and a power terminal;
the base strip being mounted onto the base plate;
the plurality of LED bulbs being distributed along the base strip;
the plurality of LED bulbs being mounted onto the base strip, opposite the base plate; and
each of the plurality of LED bulbs being electrically connected to the power terminal through the constant current driver.
